(19) United States
(12) Patent Application Publication
(10) Pub. No.: US 2025/0304008 A1
(43) Pub. Date: Oct. 2, 2025

(54) ENTRY SYSTEM AND ENTRY CONTROL METHOD

(71) Applicant: HONDA MOTOR CO., LTD., Tokyo (JP)

(72) Inventors: Shuto Higashi, Tokyo (JP); Seonghun Lee, Tokyo (JP)

(21) Appl. No.: 19/054,271

(22) Filed: Feb. 14, 2025

(30) Foreign Application Priority Data
Mar. 29, 2024 (JP) 2024-055945

(51) Int. Cl. B60R 25/25; B60R 25/04; B60R 25/30; G06V 40/16; G06V 40/20; G06V 40/50; G07C 9/00; G07C 9/37

(52) U.S. Cl. CPC B60R 25/25; B60R 25/04; B60R 25/305; G06V 40/172; G06V 40/20; G06V 40/50; G07C 9/00563; G07C 9/37; G06V 2201/07; G07C 2209/08

(57) ABSTRACT

An entry system includes: an acquisition unit configured to acquire personal data of a target person who intends to utilize a moving body; an authentication unit configured to collate the acquired personal data with authentication data of a registered user stored in a storage device, and to authenticate that the target person is the registered user based on the acquired personal data of the target person; and a management unit configured to manage the authentication data, and the management unit updates the authentication data for the registered user who is the target person based on the acquired personal data of the target person, when authentication of the target person is a success in the authentication unit.

### INCORPORATION BY REFERENCE

The present application claims priority under 35 U.S.C. § 119 to Japanese Patent Application No. 2024-055945 filed on Mar. 29, 2024. The content of the application is incorporated herein by reference in its entirety.

### BACKGROUND OF THE INVENTION

### Field of the Invention

The present invention relates to an entry system and an entry control method for a moving body.

### Description of the Related Art

In recent years, an approach of providing access to a sustainable transportation system considering even vulnerable people like aged people, people with disabilities and children among traffic participants is gaining momentum. Towards the realization, the focus is on research and development for further improving traffic safety and convenience through development regarding vehicle accessibility.

U.S. patent Ser. No. 10/745,018 discloses technology of capturing two types of biological data of a user for vehicle access and control, and permitting the vehicle access and control by the user when the captured biological data coincides with biological data for authentication, which has been registered beforehand.

Now, for vehicle accessibility, a problem is to improve suitability of authentication and confidentiality of personal data when performing authentication using personal data of a user such as biological data.

For example, authentication data stored in a system in order to be collated with personal data needs to clearly express features of the personal data so that the system does not erroneously determine whether or not a target person is a proper user of a vehicle. On the other hand, for example, authentication data based on a face image may deviate from the features of an individual at present depending on a physical condition, a body shape, and a hairstyle or the like of the individual when the face image is photographed and the change due to lapse of time after photographing. In addition, vehicles are frequently transferred to other people, and if minute personal information like the biological data is left in a storage device of a transferred vehicle, it may cause a vehicle user to feel anxiety regarding protection of the personal information.

In order to solve the above-described problem, an object of the present application is to effectively protect authentication data as personal information of a user of a moving body while enabling appropriate individual authentication of the user, thereby contributing to development of a sustainable transportation system.

### SUMMARY OF THE INVENTION

One mode of the present invention aspect is an entry system including: an acquisition unit configured to acquire personal data of a target person who intends to utilize a moving body; an authentication unit configured to collate the acquired personal data with authentication data of a registered user stored in a storage device, and to authenticate that the target person is the registered user based on the acquired personal data of the target person; and a management unit configured to manage the authentication data. The management unit updates the authentication data for the registered user who is the target person based on the acquired personal data of the target person, when authentication of the target person is a success in the authentication unit.

One mode of the present invention aspect is an entry control method conducted by a computer of an entry system, and the method includes: an acquisition step of acquiring personal data of a target person who intends to utilize a moving body; an authentication step of collating the acquired personal data with authentication data of a registered user stored in a storage device, and authenticating that the target person is the registered user based on the acquired personal data of the target person; and a management step of managing the authentication data. In the management step, the authentication data for the registered user who is the target person is updated based on the acquired personal data of the target person, when authentication of the target person is a success in the authentication step.

According to the present invention aspect, personal data of a user of a moving body used for authentication can be effectively protected while enabling appropriate individual authentication of the user.

### BRIEF DESCRIPTION OF THE DRAWINGS

FIG. 1 is a diagram illustrating an example of a configuration of a moving body loaded with an entry system according to one embodiment of the present invention;

FIG. 2 is a diagram illustrating a configuration of the entry system;

FIG. 3 is a diagram for describing a detection operation of a target person approaching the moving body; and

FIG. 4 is a flowchart illustrating a procedure of an operation in the entry system.

### DETAILED DESCRIPTION OF THE INVENTION

Hereinafter, embodiments of the present invention will be described with reference to the drawings.

### 1. Configuration of Vehicle

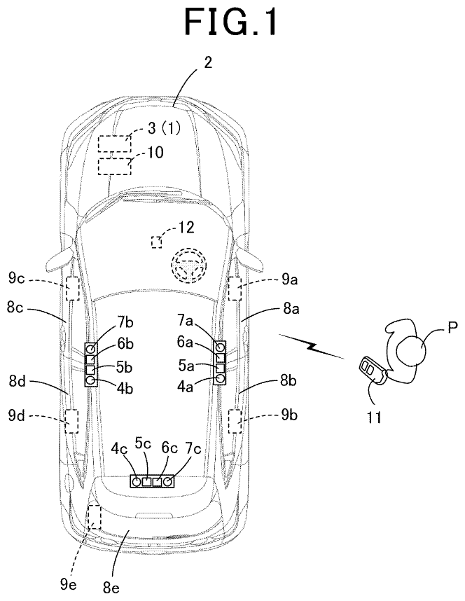

FIG. 1 is a diagram illustrating a configuration of a moving body 2 loaded with an entry system 1 of the present embodiment. The moving body 2 includes an entry controller 3 forming the entry system 1. The entry system 1 is loaded in the moving body 2, authenticates a target person P who is an arbitrary person who intends to perform entry into the moving body 2, and enables utilization of the moving body 2 by the target person P when it is authenticated that the target person P is a person who has proper authority to utilize the moving body 2. Here, “entry” to the moving body 2 refers at least to boarding (or getting into) the moving body 2 from outside of the moving body 2, and may further include starting utilization of a system of the moving body 2 by login to the system after boarding. For example, shifting the moving body 2 to a state where the target person P can start a driving operation such as enabling start of a drive unit (such as an engine and a motor) provided in the moving body 2 by login or the like to the system of the moving body 2 may be included.

In the present embodiment, the moving body 2 is, for example, a passenger car, and may be a shared car that a plurality of persons can board. Yet, the moving body 2 is not limited to a passenger car, and may be an arbitrary moving body. Such a moving body may be, in addition to a land moving body such as a passenger car, a bus, a taxi, and a train, a marine moving body such as a ship and a submarine, or an air moving body such as an aircraft including an eVTOL (Electric Vertical Take-Off and Landing aircraft) and an airship.

On a right side part of the moving body 2, a right object detection sensor 4a that detects an object present on a right side of the moving body 2, a first right camera 5a and a second right camera 6a that photograph the right side of the moving body 2, and a right illuminator 7a that illuminates the right side of the moving body 2 are provided.

On a left side part of the moving body 2, a left object detection sensor 4b that detects an object present on a left side of the moving body 2, a first left camera 5b and a second left camera 6b that photograph the left side of the moving body 2, and a left illuminator 7b that illuminates the left side of the moving body 2 are provided.

On a rear part of the moving body 2, a rear object detection sensor 4c that detects an object present in a rear of the moving body 2, a first rear camera Sc and a second rear camera 6c that photograph the rear of the moving body 2, and a rear illuminator 7c that illuminates the rear of the moving body 2 are provided.

Hereinafter, the right object detection sensor 4a, the left object detection sensor 4b, and the rear object detection sensor 4c are noted as an object detection sensor 4 when not to be distinguished. In addition, the first right camera 5a, the first left camera 5b, and the first rear camera Sc are noted as a first camera 5 when not to be distinguished. Further, the second right camera 6a, the second left camera 6b, and the second rear camera 6c are noted as a second camera 6 when not to be distinguished. Also, the right illuminator 7a, the left illuminator 7b, and the rear illuminator 7c are noted as an illuminator 7 when not to be distinguished.

The second camera 6 has higher resolution and power consumption as compared with the first camera 5.

The first camera 5 and the second camera 6 are, for example, CCD cameras having different pixel numbers. In addition, the object detection sensor 4 is, for example, a ranging sensor capable of detecting a surrounding object and measuring a distance to the object, and is a millimeter wave radar in the present embodiment. The object detection sensor 4 is not limited to the radar, and may be an arbitrary ranging sensor capable of object detection and distance measurement. Such a sensor may be, in addition to a radar, a LiDar, or a sonar or the like.

The illuminator 7 can be formed using an arbitrary light emitter or light emitting element, for example. In the present embodiment, the illuminator 7 is, for example, an LED projector.

The moving body 2 also includes a door switch 9 provided in each of doors 8 of the moving body 2 to lock and unlock a door lock of the door 8 and to open and close the door 8. The door switch 9 may include an actuator that locks and unlock the door lock of the corresponding door 8 and an actuator that opens and closes the door 8.

In the present embodiment, the moving body 2 includes, as the doors 8 and the door switches 9, a right front door switch 9a provided on a driver's seat door 8a at a right front of the moving body 2, and a right rear door switch 9b provided on a right rear seat door 8b at a right rear of the moving body 2. In addition, the moving body 2 includes a left front door switch 9c provided on a passenger seat door 8c at a left front of the moving body 2, and a left rear door switch 9d provided on a left rear seat door 8d at a left rear of the moving body 2. The moving body 2 further includes a back door switch 9e provided on a back door (tailgate door) 8e of the moving body 2.

The moving body 2 also includes a communication device 10. The communication device 10 includes a transmitter-receiver for communicating with an electronic key 11 used to utilize the moving body 2. The electronic key 11 may be, for example, a smart key such as a FOB key, or a portable terminal such as a smartphone storing key information used to utilize the moving body 2.

The moving body 2 may also include an interior camera 12 that captures an image of an interior of the moving body 2 at the front of the interior of the moving body 2. The interior camera 12 can capture the image of the interior including a face of a driver sitting in a driver's seat of the moving body 2. For example, the interior camera 12 may be, when the moving body 2 is a vehicle, a driver monitoring camera (DMC) provided substantially near a center in a vehicle width direction of an instrument panel (not illustrated) inside a vehicle interior. Note that the interior camera 12 may be disposed at an arbitrary position from which the image of the interior including the face of the driver can be captured, such as a lower part of a room mirror, without being limited to the instrument panel.

### 2. Configuration of Entry System

The configuration of the entry system 1 will be described.

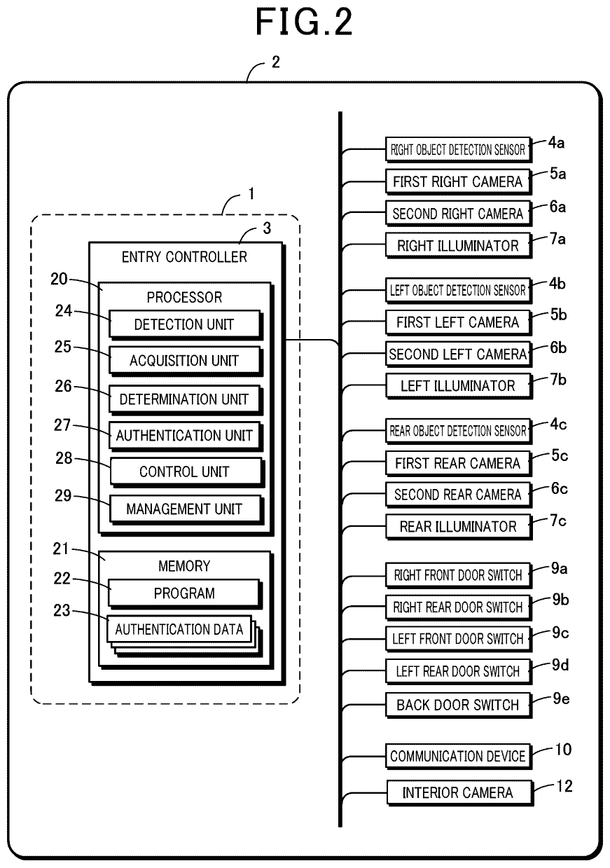

FIG. 2 is a diagram illustrating the configuration of the entry system 1. The entry system 1 at least includes the entry controller 3. The entry controller 3 authenticates the target person P who is an arbitrary person who intends to perform entry into the moving body 2, and enables the utilization of the moving body 2 by the target person P when the target person P is authenticated. The authentication is conducted by collating personal data acquired for the target person P with authentication data of a registered user stored in a storage device beforehand.

Note that, hereinafter, a “target person” is a person defined as a target of the authentication by the entry system 1. In addition, a “user” is a registered user registered beforehand as a person who has proper authority to utilize the moving body 2, and is a person who actually utilizes the moving body 2. The target person P becomes the user when the target person P is authenticated by the entry controller 3 and the utilization of the moving body 2 is enabled.

The personal data used for the authentication may be arbitrary data that can be used to identify or specify the target person P. For example, the personal data may be physical data or biological data of the target person P. The physical data or the biological data may be one of a face image, a fingerprint image, an iris image, a vein image extracted from a skin image, and a voiceprint extracted from voice or the like, or a combination of the two or more.

In the present embodiment, the personal data acquired for the authentication is a face image.

Some of functional elements of the entry controller 3 indicated below may be provided in another device. For example, a control unit 28 (to be described later) provided in the entry controller 3 may be realized as a functional element of another electronic control unit (ECU) that controls an operation of the moving body 2. In this case, the entry system 1 includes the entry controller 3 and the electronic control unit, and the entry controller 3 communicates with the electronic control unit, and makes a function of the control unit 28 be executed in the electronic control unit.

The entry system 1 may also include other instruments such as the object detection sensor 4, the first camera 5 and the second camera 6 used by the entry controller 3.

The entry controller 3 includes a processor 20 and a memory 21. The memory 21 is formed of, for example, a volatile or nonvolatile semiconductor memory and/or a hard disk device or the like. In the memory 21, authentication data 23 is preserved for each of one, two or more registered users registered beforehand as persons who have the proper authority to utilize the moving body 2.

The processor 20 is a computer including a CPU or the like, for example. The processor 20 may be configured to include a ROM in which a program is written, and a RAM for temporarily storing data or the like. Then, the processor 20 includes, as the functional elements or functional units, a detection unit 24, an acquisition unit 25, a determination unit 26, an authentication unit 27, the control unit 28, and a management unit 29.

The functional elements provided in the processor 20 are realized by the processor 20 which is a computer executing a program 22 preserved in the memory 21. Note that the program 22 can be stored in an arbitrary computer-readable storage medium. Instead, all or some of the functional elements provided in the processor 20 may be formed of hardware including one or more electronic circuit components, respectively.

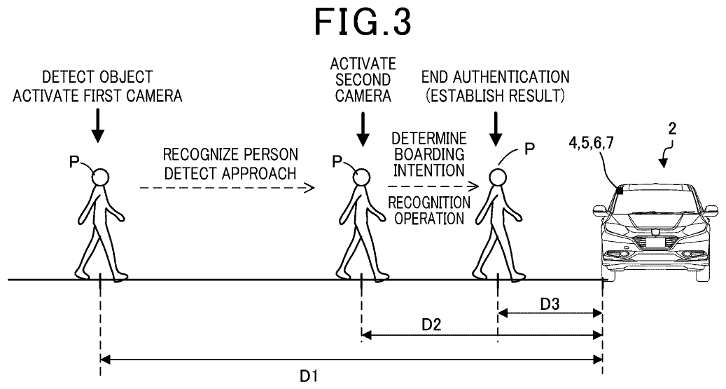

The detection unit 24 uses the object detection sensor 4 and the first camera 5 to detect the target person P approaching the moving body 2. The detection unit 24 is operated as illustrated in FIG. 3, for example. FIG. 3 is an explanatory diagram for describing the operation of the detection unit 24.

First, the detection unit 24 determines whether or not an entity (or an object) has entered a range of a prescribed distance D1 determined beforehand from the moving body 2 by the object detection sensor 4. The entity may be an arbitrary object including a living thing and a nonliving thing. When the entity has entered the range of the prescribed distance D1, the detection unit 24 activates the first camera 5 close to the object detection sensor 4 which has detected the entity.

The detection unit 24 successively acquires a first image around the moving body 2 by the activated first camera 5 at a prescribed time interval. The detection unit 24 performs image recognition processing for the first image photographed by the first camera 5, and determines whether or not the entity is a person. When the entity is a person, the detection unit 24 determines whether or not the person is approaching the moving body 2 from the first image successively photographed by the first camera 5. When the person is approaching the moving body 2, the detection unit 24 determines the person as the target person P. Thus, the detection unit 24 detects the target person P approaching the moving body 2. When the target person P is detected, the detection unit 24 notifies the acquisition unit 25 of that effect. In an example illustrated in FIG. 3, the detection unit 24 determines that the entity is a person approaching the moving body 2 while the entity detected by the object detection sensor 4 advances to a position at a distance D2 from the moving body 2, and notifies the acquisition unit 25 of that the target person P is detected when the person reaches the position at the distance D2.

The acquisition unit 25 acquires the personal data of the target person P who intends to utilize the moving body 2. In the present embodiment, the personal data is, for example, a face image of the target person P. When the target person P is detected in the detection unit 24, the acquisition unit 25 activates the second camera 6 near the first camera 5 used to detect the target person P, and acquires a second image of the target person P by the activated second camera 6 at the prescribed time interval. When it is dark around the moving body 2 at the time of activating the second camera 6, the acquisition unit 25 may light the illuminator 7 near the activated second camera 6.

As described above, the second camera 6 has higher resolution and power consumption as compared with the first camera 5.

The acquisition unit 25 successively photographs the high-definition second image of the target person P by the activated second camera 6 at the prescribed time interval. The acquisition unit 25 extracts the face image of the target person P from the second image every time the second image of the target person P is photographed, and acquires the plurality of face images of the target person P captured at the prescribed time interval. Every time the second image of the target person P is photographed, the acquisition unit 25 sends the photographed image of the target person P and the extracted face image to the determination unit 26 and the authentication unit 27.

The determination unit 26 determines presence/absence of an intention of the target person P to board the moving body 2 based on movement of the target person P recognized from the plurality of second images captured at the prescribed time interval. For example, the determination unit 26 can determine that the target person P has an intention to board the moving body 2 when the target person P is approaching one of the doors 8 of the moving body 2 further, when the target person P stops in front of one of the doors 8 of the moving body 2, and when the target person P reaches his/her hand to a doorknob of one of the doors 8 or the like.

In an example illustrated in FIG. 3, the determination unit 26 determines the presence/absence of the boarding intention of the target person P at a position at a distance D3 from the moving body 2, for example.

The determination unit 26 notifies the authentication unit 27 of a result of determining the presence/absence of the intention of the target person P to board the moving body 2.

The authentication unit 27 collates the face image as the personal data acquired by the acquisition unit 25 with the authentication data 23 of the registered user recorded in the memory 21 which is the storage device. Thus, the authentication unit 27 authenticates that the target person P is the registered user based on the acquired face image which is the personal data of the target person P.

As described above, since the acquisition unit 25 sends the photographed image and the face image of the target person P to the authentication unit 27 every time the second image of the target person P is photographed, the authentication unit 27 can authenticate the target person P in parallel with acquisition of the second image in the acquisition unit 25. For example, in the example in FIG. 3, the authentication unit 27 can operate so as to complete the authentication of the target person P at the position at the distance D3 at which the determination unit 26 completes determination on the presence/absence of the boarding intention of the target person P.

Specifically, the authentication unit 27 calculates a feature amount of the face image for the face image acquired by the acquisition unit 25, and calculates, for each registered user, a collation score indicating a degree of coincidence between the calculated feature amount (target feature amount, hereinafter) and a feature amount (authentication feature amount, hereinafter) of the face image preserved in the authentication data 23 of each registered user stored in the memory 21.

Then, the authentication unit 27 determines whether or not the target person P is one of the registered users based on the calculated collation scores. Specifically, for example, when there are collation scores equal to or higher than a first prescribed value in the calculated collation scores, the authentication unit 27 authenticates that the target person P is the registered user corresponding to the collation score indicating a highest value among the collation scores equal to or higher than the first prescribed value. Thus, the authentication for the target person P becomes a success.

On the other hand, when there are not the collation scores equal to or higher than the first prescribed value in the calculated collation scores, the authentication unit 27 determines that the target person P is not a registered user. Thus, the authentication for the target person P becomes a failure.

Here, the authentication unit 27 may calculate the collation score for each of the plurality of face images of the target person P extracted respectively from the plurality of images acquired by the acquisition unit 25 at the prescribed time interval, and determine presence/absence of the registered user corresponding to the target person P based on the calculated collation score. In this case, when the registered user corresponding to the target person P determined for each of the plurality of face images is the same one registered user with a possibility of a predetermined value or higher in the plurality of face images, the authentication unit 27 may determine that the target person P is the one registered user. When the one registered user cannot be specified, the authentication unit 27 can determine that the target person P is not a registered user.

When authenticating the target person P, the authentication unit 27 may perform so-called liveness determination on whether or not the face image acquired as the personal data for the target person P is an image of an actual face of the target person P. When it is determined that the acquired face image is not the image of the actual face of the target person P himself/herself and is, for example, an image of a head part of a third person wearing a mask on which a face photo is printed or the like in the liveness determination, the authentication unit 27 may determine that the authentication using the face image as a failure.

Specifically, the authentication unit 27 may authenticate whether or not the target person P is a registered user based on the face images on condition that respective hues of the face images extracted from each of the plurality of images successively captured from the second camera 6 by the detection unit 24 at the prescribed time interval and/or time-sequential brightness distribution change of the face images satisfies a predetermined standard, for example. Here, for example, the standard may be that the hue that the face image has is not the hue peculiar to a printed matter and/or that illumination to the face of the target person P recognized from the plurality of time-sequential face images successively changes without inconsistency, or the like.

Thus, for example, it is possible to effectively prevent the target person P who intends to perform unauthorized entry into the moving body 2, for example, by wearing a mask printed with a face image of a registered user who is a different person.

The authentication unit 27 may authenticate that the target person P is a registered user when the determination unit 26 determines that the target person P has an intention to board the moving body 2. Thus, it is possible to prevent the authentication unit 27 from unnecessarily authenticating a person who is not trying to board the moving body 2 as the target person P.

In addition, the authentication unit 27 may authenticate that the target person P is a registered user on condition that a gesture made by the target person P coincides with an authentication gesture registered beforehand, based on the plurality of images successively captured from the second camera 6 by the detection unit 24 at the prescribed time interval. The authentication gesture may be formed of time-sequential images acquired from the registered user beforehand and preserved in the memory 21, for example.

Thus, the target person P can be more appropriately authenticated based also on the gesture of the target person P.

When the authentication of the target person P is a success in the authentication unit 27, the control unit 28 controls the moving body 2 and enables the utilization of the moving body 2 by the target person P. In the present embodiment, for example, the control unit 28 instructs the door switch 9 of the moving body 2 to automatically unlock the door lock of the door 8, when the authentication of the target person P is a success in the authentication unit 27. At the time, the control unit 28 may instruct the door switch 9 to automatically open the door 8 after the door 8 is unlocked. The control unit 28 may execute automatic unlocking and automatic opening operations with the door 8 closest to the target person P as a target, for example. The door 8 closest to the target person P can be specified from the lately acquired second image and notified to the control unit 28 by the acquisition unit 25, for example.

Further, the control unit 28 may start the moving body 2 on condition that the authentication of the target person P is a success in the authentication unit 27. For example, the control unit 28 may permit a controller (not illustrated) loaded in the moving body 2 to execute a start operation for the moving body 2 to be performed by the target person P on condition that the target person P who has succeeded in the authentication has boarded the moving body 2 from the driver's seat door 8a.

The management unit 29 manages the authentication data 23 of the registered user. In the present embodiment, when the authentication of the target person P is a success in the authentication unit 27, the management unit 29 updates the authentication data 23 for the registered user who is the target person P, based on the personal data of the target person P acquired by the acquisition unit 25. For example, the management unit 29 calculates a feature amount of the face image which is the personal data, and updates the authentication data 23 with the calculated feature amount.

Thus, since the authentication data 23 of a user who is the registered user of the moving body 2 is updated based on the latest personal data, an authentication operation can be appropriately performed with the latest authentication data 23. In addition, since the user's utilization history of the moving body 2 can be kept as an update history of the authentication data 23, it is possible to appropriately determine presence/absence of necessity to erase the authentication data 23 which is the personal information based on the update history, such as erasing the authentication data when the moving body 2 is not to be utilized for a long period of time, for example.

Further, the management unit 29 manages elapsed time from the latest update for each piece of the authentication data 23 recorded in the memory 21, and deletes, from the memory 21, the authentication data for which first time determined beforehand has elapsed as the elapsed time among the authentication data 23 recorded in the memory 21.

Thus, since a non-use state of the moving body 2 by the user is recognized from update date and time as the update history of the authentication data 23 and the authentication data 23 that is going to be unneeded is erased, the authentication data 23 which is the personal information of the user can be effectively protected.

For example, the management unit 29 stores information of the date and time when the authentication data 23 is updated in the memory 21 as the update date and time corresponding to the updated authentication data 23. Thereafter, the management unit 29 can recognize the elapsed time from the latest update of the authentication data 23 by comparing the present date and time with the update date and time.

Note that the management unit 29 may update the authentication data when the authentication for the target person P who is the corresponding registered user is a success for the authentication data for which predetermined second time shorter than the first time has elapsed as the elapsed time from the latest update among the authentication data 23 recorded in the memory 21.

Thus, it is possible to avoid unnecessarily frequently updating the authentication data 23 of the registered user who highly frequently utilizes the moving body 2, and realize a stable authentication operation.

Here, the second time described above can be set beforehand by the corresponding registered user for each piece of the authentication data 23.

Thus, the registered user can prevent his/her own authentication data 23 from being unnecessarily frequently updated by setting the second time according to his/her utilization frequency for the moving body 2, for example.

### 3. Operation of Entry System

Next, a procedure of the operation of the entry system 1 will be described.

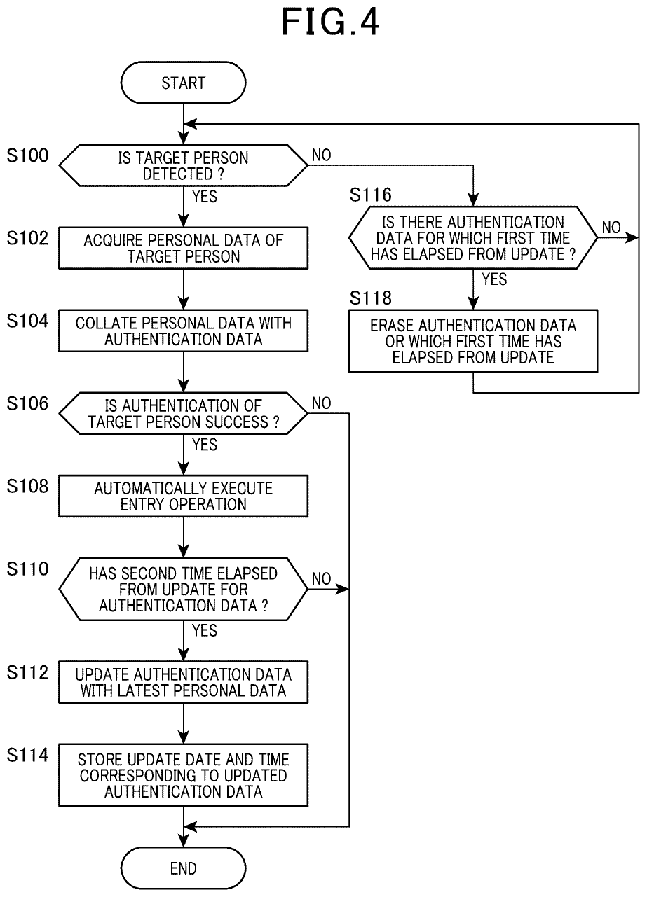

FIG. 4 is a flowchart illustrating a procedure of an entry control method executed by a computer of the entry system 1. The computer of the entry system 1 is the processor 20 of the entry controller 3 as an example in the present embodiment.

Processing illustrated in FIG. 4 is started when power sources of respective instruments illustrated in FIG. 2 including the entry controller 3 are turned on, and is repeatedly executed.

When the processing is started, first, the detection unit 24 determines whether or not the target person P approaching the moving body 2 is detected (S100). Then, when the target person P is not detected (S100, NO), the management unit 29 determines whether or not the authentication data 23 for which the first time has elapsed from the latest update is stored in the memory 21 (S116).

Then, when the authentication data 23 for which the first time has elapsed from the latest update is stored in the memory 21 (S116, YES), the management unit 29 erases the authentication data 23 for which the first time has elapsed from the latest update from the memory 21 (S118). Thereafter, the management unit 29 returns the processing to step S100.

On the other hand, when the authentication data 23 for which the first time has elapsed from the latest update is not stored in the memory 21 (S116, NO), the management unit 29 returns the processing to step S100.

Meanwhile, when the target person P is detected in step S100 (S100, YES), the acquisition unit 25 acquires the personal data of the target person P (S102). The authentication unit 27 collates the acquired personal data with the authentication data 23 of each registered user stored in the memory 21 (S104). The authentication unit 27 determines whether or not the authentication of the target person P is a success by the collation (S106).

Then, when the authentication is a success (S106, YES), the control unit 28 executes a prescribed entry operation (S108). The prescribed entry operation may be, for example, an automatic unlocking operation of the door 8 of the moving body 2. Thereafter, the management unit 29 determines whether or not the second time has elapsed from the latest update for the authentication data 23 of the registered user corresponding to the target person P (S110).

Then, when the second time has elapsed from the latest update for the authentication data 23 of the registered user corresponding to the target person P (S110, YES), the management unit 29 updates the authentication data 23 of the registered user corresponding to the target person P, that is stored in the memory 21, using the latest personal data for the target person P acquired by the acquisition unit 25 in step S102 (S112). Next, the management unit 29 stores the information of the date and time when the authentication data 23 is updated in the memory 21 as the update date and time corresponding to the updated authentication data 23 (S114). Thereafter, the management unit 29 ends the present processing.

On the other hand, when the authentication of the target person P is a failure in step S106, that is, when it is determined that the target person P is not a registered user (S106, NO), the management unit 29 ends the present processing.

In addition, when the second time has not elapsed from the latest update for the authentication data 23 of the registered user corresponding to the target person P in step S110 (S110, NO), the management unit 29 ends the present processing.

After the present processing is ended, the processor 20 of the entry controller 3 repeats the processing from step S100 anew.

Here, in FIG. 4, steps S102 and S104 correspond to an acquisition step and an authentication step in the present disclosure, respectively. Further, steps S110 to S118 correspond to a management step in the present disclosure.

### 4. Other Embodiments

The acquisition unit 25 of the entry controller 3 may acquire an image of the interior of the moving body 2 including a face image of a person (for example, the target person P) sitting in a driver's seat by the interior camera 12 and transmit the image to the authentication unit 27 after the target person P is authenticated by the authentication unit 27 and the control unit 28 unlocks the door 8. The authentication unit 27 can further authenticate whether or not the person is a registered user by the face image of the person in the driver's seat, that is photographed in the image of the interior.

The control unit 28 can shift a state of the moving body 2 so as to enable execution of the start operation for the moving body 2 to be performed by the person (including start of a drive unit such as an engine and a motor), on condition that the authentication unit 27 has authenticated the person in the driver's seat in addition to the authentication of the target person P by the authentication unit 27.

Note that the present invention is not limited to the configuration of the embodiments described above, and can be implemented in various modes without deviating from the gist.

### 5. Configurations Supported by Embodiments Described Above

The embodiments described above support the following configurations.

(Configuration 1) An entry system including: an acquisition unit configured to acquire personal data of a target person who intends to utilize a moving body; an authentication unit configured to collate the acquired personal data with authentication data of a registered user stored in a storage device, and to authenticate that the target person is the registered user based on the acquired personal data of the target person; and a management unit configured to manage the authentication data, wherein the management unit updates the authentication data for the registered user who is the target person based on the acquired personal data of the target person, when authentication of the target person is a success in the authentication unit.

According to the entry system of configuration 1, since the authentication data of a user who is a registered user of the moving body is updated based on the latest personal data, the authentication operation can be appropriately performed with the latest authentication data. In addition, according to the entry system of configuration 1, since the moving body utilization history of the user can be kept as the update history of the authentication data, it is possible to determine presence/absence of the necessity to erase the authentication data which is the personal information based on the update history, such as erasing the authentication data when the moving body is not to be utilized for a long period of time, for example.

(Configuration 2) The entry system according to configuration 1, wherein the management unit manages elapsed time from latest update for each piece of the authentication data, and deletes, from the storage device, the authentication data for which predetermined first time has elapsed as the elapsed time among the authentication data stored in the storage device.

According to the entry system of configuration 2, since the non-use state of the moving body by the user is recognized from the update history of the authentication data and the authentication data that is going to be unneeded is erased, the authentication data which is the personal information of the user can be effectively protected.

(Configuration 3) The entry system according to configuration 2, wherein the management unit updates the authentication data when authentication for the target person who is the corresponding registered user is a success, for the authentication data for which predetermined second time shorter than the first time has elapsed as the elapsed time, among the authentication data stored in the storage device.

According to the entry system of configuration 3, it is possible to avoid unnecessarily frequently updating the authentication data of the registered user who highly frequently utilizes the moving body, and realize the stable authentication operation.

(Configuration 4) The entry system according to configuration 3, wherein the second time is set by the corresponding registered user for each piece of the authentication data.

According to the entry system of configuration 4, the registered user can prevent the authentication data from being unnecessarily frequently updated by setting the second time according to his/her utilization frequency for the moving body, for example.

(Configuration 5) The entry system according to any one of configurations 1 to 4, wherein the acquisition unit acquires a plurality of face images of the target person captured at a prescribed time interval determined beforehand, as the personal data of the target person, and the authentication unit authenticates whether or not the target person is a registered user based on the personal data on condition that respective hues and/or time-sequential brightness distribution change of the plurality of face images of the target person satisfies a prescribed standard determined beforehand.

According to the entry system of configuration 5, it is possible to effectively prevent the target person who intends to perform unauthorized entry into the moving body, for example, by wearing a mask printed with a face image of a registered user who is a different person.

(Configuration 6) The entry system according to any one of configurations 1 to 5, wherein the authentication unit authenticates that the target person is a registered user on condition that a gesture made by the target person coincides with an authentication gesture registered beforehand, based on a plurality of images of the target person captured successively at a prescribed time interval determined beforehand.

According to the entry system of configuration 6, the target person can be more appropriately authenticated based also on the gesture of the target person.

(Configuration 7) The entry system according to any one of configurations 1 to 6, including a control unit configured to control the moving body to enable utilization of the moving body by the target person when the authentication of the target person is a success in the authentication unit, wherein the control unit unlocks a door of the moving body when the authentication of the target person is a success in the authentication unit.

According to the entry system of configuration 7, convenience of the user of the moving body can be improved.

(Configuration 8) The entry system according to configuration 7, wherein the control unit starts the moving body on condition that the authentication of the target person is a success in the authentication unit.

According to the entry system of configuration 8, the convenience of the user utilizing the moving body as a driver can be further improved.

(Configuration 9) An entry control method conducted by a computer of an entry system, the method including: an acquisition step of acquiring personal data of a target person who intends to utilize a moving body; an authentication step of collating the acquired personal data with authentication data of a registered user stored in a storage device, and authenticating that the target person is the registered user based on the acquired personal data of the target person; and a management step of managing the authentication data, wherein, in the management step, the authentication data for the registered user who is the target person is updated based on the acquired personal data of the target person, when authentication of the target person is a success in the authentication step.

According to the entry control method of configuration 9, an effect similar to that of configuration 1 is accomplished.

### REFERENCE SIGNS LIST

1 . . . entry system, 2 . . . moving body, 3 . . . entry controller, 4 . . . object detection sensor, 4a . . . right object detection sensor, 4b . . . left object detection sensor, 4c . . . rear object detection sensor, 5 . . . first camera, 5a . . . first right camera, 5b . . . first left camera, 5c . . . first rear camera, 6 . . . second camera, 6a . . . second right camera, 6b . . . second left camera, 6c . . . second rear camera, 7 . . . illuminator, 7a . . . right illuminator, 7b . . . left illuminator, 7c . . . rear illuminator, 8 . . . door, 8a . . . driver's seat door, 8b . . . right rear seat door, 8c . . . passenger seat door, 8d . . . left rear seat door, 8e . . . back door, 9 . . . door switch, 9a . . . right front door switch, 9b . . . right rear door switch, 9c . . . left front door switch, 9d . . . left rear door switch, 9e . . . back door switch, 10 . . . communication device, 11 . . . electronic key, 12 . . . interior camera, 20 . . . processor, 21 . . . memory, 22 . . . program, 23 . . . authentication data, 24 . . . detection unit, 25 . . . acquisition unit, 26 . . . determination unit, 27 . . . authentication unit, 28 . . . control unit, 29 . . . management unit.

1. An entry system comprising:
an acquisition unit configured to acquire personal data of a target person who intends to utilize a moving body;
an authentication unit configured to collate the acquired personal data with authentication data of a registered user stored in a storage device, and to authenticate that the target person is the registered user based on the acquired personal data of the target person; and
a management unit configured to manage the authentication data,
wherein the management unit updates the authentication data for the registered user who is the target person based on the acquired personal data of the target person, when authentication of the target person is a success in the authentication unit.

2. The entry system according to claim 1,
wherein the management unit manages elapsed time from a latest update for each piece of the authentication data, and deletes, from the storage device, the authentication data for which predetermined first time has elapsed as the elapsed time among the authentication data stored in the storage device.

3. The entry system according to claim 2,
wherein the management unit updates the authentication data when authentication for the target person who is the corresponding registered user is a success, for the authentication data for which predetermined second time shorter than the first time has elapsed as the elapsed time, among the authentication data stored in the storage device.

4. The entry system according to claim 3,
wherein the second time is set by the corresponding registered user for each piece of the authentication data.

5. The entry system according to claim 1,
wherein the acquisition unit acquires a plurality of face images of the target person captured at a prescribed time interval determined beforehand, as the personal data of the target person, and
the authentication unit authenticates whether or not the target person is a registered user based on the personal data on condition that respective hues and/or time-sequential brightness distribution change of the plurality of face images of the target person satisfies a prescribed standard determined beforehand.

6. The entry system according to claim 1,
wherein the authentication unit authenticates that the target person is a registered user on condition that a gesture made by the target person coincides with an authentication gesture registered beforehand, based on a plurality of images of the target person captured successively at a prescribed time interval determined beforehand.

7. The entry system according to claim 1, comprising
a control unit configured to control the moving body to enable utilization of the moving body by the target person when the authentication of the target person is a success in the authentication unit, wherein
the control unit unlocks a door of the moving body when the authentication of the target person is a success in the authentication unit.

8. The entry system according to claim 7,
wherein the control unit starts the moving body on condition that the authentication of the target person is a success in the authentication unit.

9. An entry control method conducted by a computer of an entry system, the method comprising:
an acquisition step of acquiring personal data of a target person who intends to utilize a moving body;
an authentication step of collating the acquired personal data with authentication data of a registered user stored in a storage device, and authenticating that the target person is the registered user based on the acquired personal data of the target person; and
a management step of managing the authentication data,
wherein, in the management step, the authentication data for the registered user who is the target person is updated based on the acquired personal data of the target person, when authentication of the target person is a success in the authentication step.
